(19) United States
(12) Patent Application Publication
(10) Pub. No.: US 2013/0166603 A1
(43) Pub. Date: Jun. 27, 2013

(54) CONSUMER-RELATED SPECIALIZATION OF METADATA MODELS BASED ON A TEMPLATE-PROJECTION APPROACH

(71) Applicants: Bare Said, Sankt Leon-ROT (DE); Frank Jentsch, Muehlhausen (DE); Frank Brunswig, Heidelberg (DE)

(72) Inventors: Bare Said, Sankt Leon-ROT (DE); Frank Jentsch, Muehlhausen (DE); Frank Brunswig, Heidelberg (DE)

(73) Assignee: SAP AG, Walldorf (DE)

(21) Appl. No.: 13/337,980

(22) Filed: Dec. 27, 2011

(51) Int. Cl. G06F 17/30

(52) U.S. Cl. 707/802; 707/E17.055

(57) ABSTRACT

The present description refers to a computer implemented method, computer program product, and computer system for receiving a metadata model template that generically defines structure and behavior for a plurality of metadata models, the metadata model template including a union of the attributes and services needed by runtime engines associated with any of the metadata models, receiving a first runtime engine-specific projection definition that identifies a first subset of the attributes that have been selected and the services that have been enabled for a first runtime engine, and generating a first metadata model projection based on the metadata model template and the first runtime engine-specific projection definition, the first metadata model projection associated with the first runtime engine.

### TECHNICAL FIELD

This description is directed generally to metadata models, and in particular, to a consumer-related specialization of metadata models based on a template-projection approach.

### BACKGROUND

Data models may define structure and behavior of one or more corresponding data objects. For example, a M1 model may define a specific structure (e.g., hierarchical nodes and associated fields or attributes) and behavior (e.g., one or more enabled services) for a specific type of business object.

Business objects are real world entities modeled as objects in an information system. Business objects encapsulate both data structures and the functions or services applied to the data, while hiding their full complexity from other objects. This encapsulation of data and functions/services makes it easier to modify program components by allowing one to program with the relevant entities without having to know all the implementation details. Business objects also allow for the reuse of existing functions.

### SUMMARY

In one general aspect, a computer program product is provided. The computer program product is tangibly embodied on a computer-readable storage medium and includes executable code that, when executed, is configured to cause at least one data processing apparatus to receive a metadata model template that generically defines structure and behavior for a plurality of metadata models, the metadata model template including a union of the attributes and services needed by runtime engines associated with any of the metadata models, receive a first runtime engine-specific projection definition that identifies a first subset of the attributes that have been selected and the services that have been enabled for a first runtime engine, and generate a first metadata model projection based on the metadata model template and the first runtime engine-specific projection definition, the first metadata model projection associated with the first runtime engine.

In another general aspect, a computer implemented method is provided that includes receiving, receiving a metadata model template that generically defines structure and behavior for a plurality of metadata models, the metadata model template including a union of the attributes and services needed by runtime engines associated with any of the metadata models. The method also includes receiving a first runtime engine-specific projection definition that identifies a first subset of the attributes that have been selected and the services that have been enabled for a first runtime engine, and generating a first metadata model projection based on the metadata model template and the first runtime engine-specific projection definition, the first metadata model projection associated with the first runtime engine.

In another general aspect, an apparatus includes template receiving logic configured to receive a metadata model template that generically defines structure and behavior for a plurality of metadata models, the metadata model template including a union of the attributes and services needed by runtime engines associated with any of the metadata models. The apparatus also includes projection definition receiving logic configured to receive a first runtime engine-specific projection definition that identifies a first subset of the attributes that have been selected and the services that have been enabled for a first runtime engine. The apparatus also includes generating logic configured to generate a first metadata model projection based on the metadata model template and the first runtime engine-specific projection definition, the first metadata model projection associated with the first runtime engine.

The subject matter described in this specification can be implemented as a method or as a system or using computer program products, tangibly embodied in information carriers, such as a CD-ROM, a DVD-ROM, a semiconductor memory, and a hard disk. Such computer program products may cause a data processing apparatus to conduct one or more operations described herein.

In addition, the subject matter described herein may also be implemented as a system including a processor and a memory coupled to the processor. The memory may encode one or more programs that cause the processor to perform one or more of the method acts described in this specification.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a system 110 according to an example implementation.

FIG. 2 is a block diagram illustrating shared metadata in a M2 metadata model according to an example implementation.

FIG. 3 is a block diagram illustrating a M2 metadata model template and M2 Projections for each of a plurality of consumers or runtime engines.

FIG. 4 is a diagram that illustrates how a M2 metadata model projection may be built from a M2 metadata model template according to an example implementation.

FIG. 5 is a block diagram illustrating a system 110 that uses a metadata model template and projection according to an example implementation.

FIG. 6 is a flow chart illustrating operation of a system that uses a metadata model template and projection according to an example implementation.

FIG. 7 is a flow chart illustrating operation of a system according to another example implementation.

FIG. 8 is a flow chart illustrating a validation operation according to an example implementation.

### DETAILED DESCRIPTION

In the following, a detailed description of examples will be given with reference to the drawings. It should be understood that various modifications to the examples may be made. In particular, elements of one example may be combined and used in other examples to form new examples.

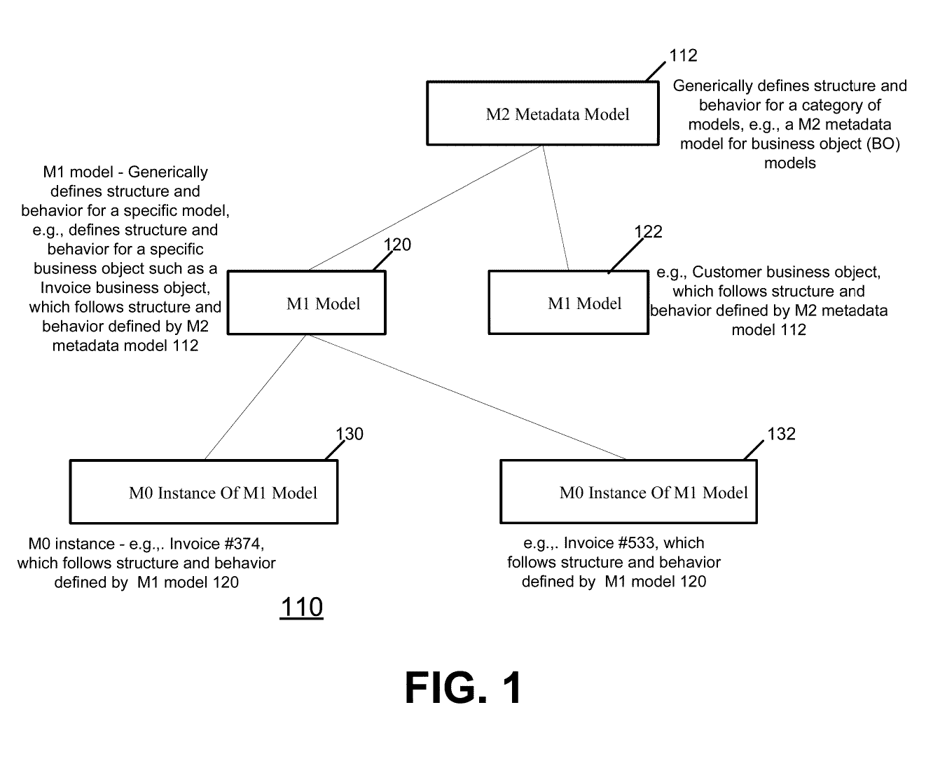

FIG. 1 is a block diagram illustrating a model system 110 according to an example implementation. A M2 Metadata model 112 generically defines structure (e.g., as including one or more hierarchical nodes with one or more possible attributes or fields) and behavior (e.g., one or more enabled services or functions) for a category of models. One example category of models may be business objects (BOs) that model real-world business activities. Another example category of models may include user interface (UI) models that may define structure and behavior for one or more UI objects that may model UI characteristics or behavior. These are merely some examples of categories of models, and many others may be used. The category of business

Two M1 models, 120 and 122, are shown in FIG. 1. The M1 models follow the structure and behavior defined by M2 metadata model 112. Each of M1 models 120 and 122 generically defines the structure and behavior of a specific business object. For example, M1 model 120 may define the structure and behavior of any M0 instances of the invoice business object 120. Similarly, M1 business object 122 may be a customer business object, for example, that may define structure and behavior for any M0 instances of the customer business object.

M0 instances 130 and 132 are shown. M0 instance 130 of M1 model 120 follows the structure and behavior defined by the M1 model 120, e.g., the invoice business object 120. For example, M0 instance 130 may be an instance of the invoice business object 120, and may include data or information related to invoice #374. Similarly, M0 instance 132 of M1 model 120 follows the structure and behavior of M1 model 120. M0 instance 132 may include data related to invoice #533, for example.

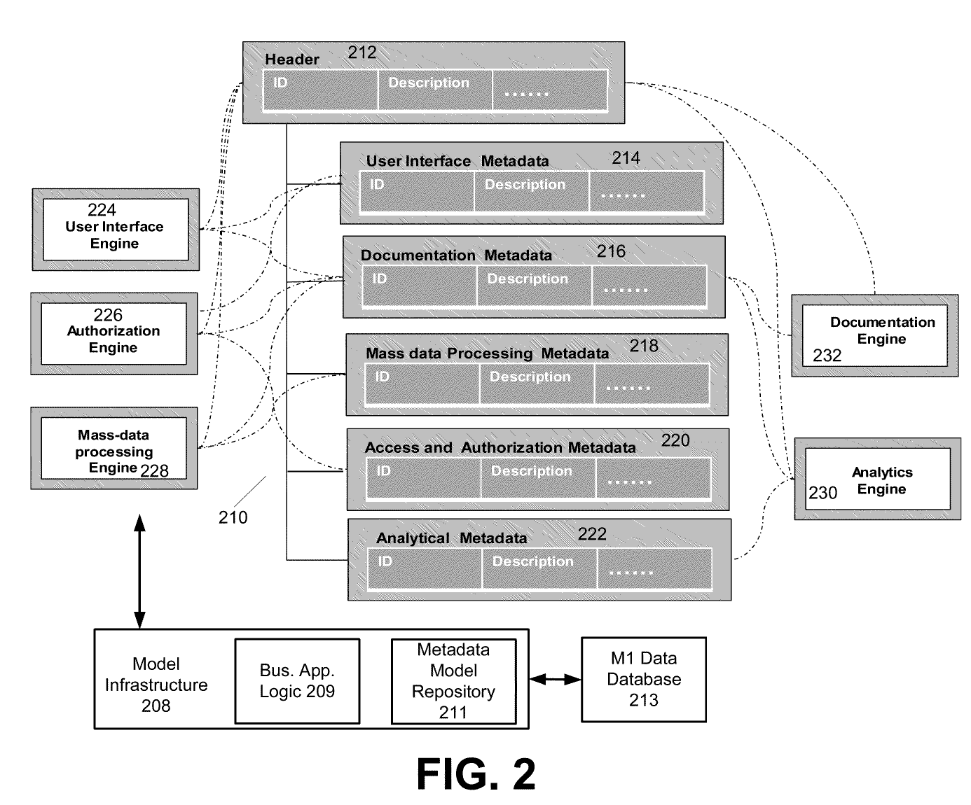

FIG. 2 is a block diagram illustrating shared metadata in a M2 metadata model according to an example implementation. The metadata is shown as being related to different aspects of a business. For example, different aspects or functions within a business or business process may include user interface, documentation, mass data processing, access and authorization, and analytical functions. These are merely some examples, and other business aspects may be used.

Referring again to FIG. 2, an example metadata model 210 may include a number of entities or nodes, such as a root node or header node 212, which may be defined to include an ID (identifier), a description and other attributes or fields. Services may also be defined or allowed for metadata model 210. Similarly, metadata model 210 may include or may identify other nodes or hierarchical entities or nodes, such as user interface (UI) metadata 214 (or that metadata relevant to the creation and display of a user interface), documentation metadata 216, a mass data processing metadata 218, access and authorization metadata 220 and analytical metadata 222.

A plurality of runtime engines are shown, where each runtime engine may consume or receive M1 model data (e.g., a M0 instance of a M1 model) from a model infrastructure 208, and may process the received data to perform one or more services or functions related to an aspect of a business based on only a portion or subset of all of the metadata in M2 metadata model 210. For example, a user interface engine 224 may perform functions or services related to user interfaces based on user interface metadata 214 and documentation metadata 216; authorization engine 226, may perform functions or services related to access and authorization based on header 212, access and authorization metadata 220; mass-data processing engine 228 may perform functions or services related to mass-data processing based on mass-data processing metadata 218; analytical engine 230 may perform functions or services related to analytical tasks based on analytical metadata 222. These are merely some examples, and the disclosure is not limited thereto.

For example, authorization engine 226 may receive a request from a user to create an M0 instance 130 corresponding to M1 model 120 and M2 metadata model 112 and authorization engine 226. Authorization engine 226 may determine whether the user has authorization to create the M0 instance 130 of the M1 model 120 (e.g., authorization to create invoice #374).

As shown in FIG. 2, the metadata of the M2 model 210 is shared among a plurality (or multiple) runtime engines, where each runtime engine only needs a small portion or subset of all of the metadata in M2 model 210. Therefore, to perform this authorization-related function or service, authorization engine 226 consumes (or uses) only the data that is relevant to this authorization-related service. Retrieving, providing and/or processing all of the data associated with M2 metadata model 210 to authorization engine may create consumability problems, e.g., a search by authorization engine 226 through the M2 metadata (or other processing and/or storage of the M2 metadata) may be required to identify the relevant data for authorization engine 226, which may require significant processing and memory resources, and may introduce significant delay, for example.

Therefore, according to an example implementation, a consumer-specific specialization of M2 metadata models may be provided. Each of the runtime engines may be considered to be consumers which may consume or use at least a portion of the metadata of the M2 metadata model 210 (and the M0 instance data for the corresponding M1 data model), for example. In an example implementation, a template-projection mechanism is used at the M2 metadata level to provide consumer-specific projections of a M2 metadata template for each consumer or runtime engine. Thus, in the example shown in FIG. 2, each runtime engine may only need a relevant subset of the M2 metadata 210 to perform its specific functions or services. Providing more data than is needed to a runtime engine may unnecessarily cause model infrastructure 208 or a computer to expend resources to process. The use of a M2 metadata model projection addresses this consumability problem of using one large model or metadata model for all consumers or runtime engines.

Thus, according to an example embodiment, a M2 metadata model template is generated or received (e.g., by model infrastructure 208 or a computing device or computer) that generically defines structure and behavior for a plurality of metadata models. The metadata model template may include or may identify a union (e.g., superset) of all of the attributes and services needed by runtime engines (or other consumers) associated with any of the metadata models. Next, a runtime engine-specific (or consumer-specific) projection definition may be input or received that identifies a subset of the attributes that have been selected and the services that have been enabled for the specific consumer or runtime engine. A metadata model projection (or custom or consumer-specific metadata model) is generated based on the metadata model template and the consumer-specific or runtime engine-specific projection definition.

The consumers or runtime engines (e.g., runtime engines 224, 226, 228, 230 and 232) in FIG. 2 may be coupled to (or in communication with) a model infrastructure 208. Model infrastructure 208 may include a business application logic 209 for performing functions related to models and metadata models, such as generating M1 data models and M2 metadata models, and generating M2 metadata model templates and M2 metadata model projections. The model infrastructure 208 may also include a metadata model repository 211 that stores all M1 data models and M2 metadata models, and M2 metadata model templates and projections, for example. The M1 data (or M0 instances of M1 models) may be stored in a M1 data database 213. A runtime engine may use an application programming interface or API provided by model infrastructure 208 to request specific M1 dat. The model infrastructure may retrieve the requested data from M1 data database 213 and provide this M1 data to the requesting runtime engine, for example.

Furthermore, providing the template-projection mechanism at the M2 metadata model level has several advantages over providing such template-projection mechanism at another level, such as at the M1 or business object level. First, as noted, through the template-projection mechanism at the M2 level, resource usage may be decreased based on the custom projections that may be used for each consumer or runtime engine. Second, an M2 level template makes it easier to construct various M2 metadata models. Also, the M2 metadata model template may be stored in the model infrastructure 208. A M2 metadata model template can be instantiated, and thus, does not represent an abstract entity as a definition template for other entities. Thus, M1 models corresponding to the M2 template may be created and accessed via the model infrastructure 208, for example. Also, the template at the M2 metadata model level that is a union of all attributes and services for each consumer-specific metadata model projection, reduces unwanted redundancy between the projections, and makes it easier to execute checks for consistency and integrity between the templates and projections, since, in an example implementation, each M2 projection may include only a subset of the metadata provided in the M2 template. In some cases, some attributes may be shared and used by different projections but persisted and implemented once in the corresponding M2 metadata model template.

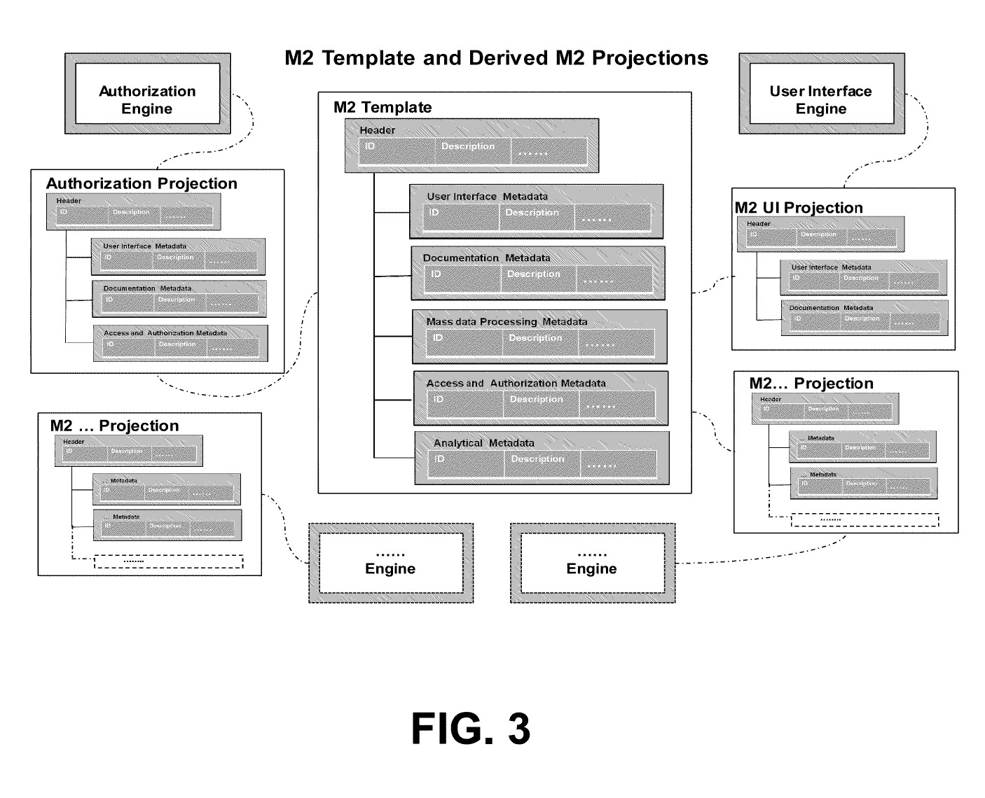

FIG. 3 is a block diagram illustrating a M2 metadata model template and M2 Projections for each of a plurality of consumers or runtime engines. In the example shown in FIG. 3, a runtime engine-specific M2 metadata model (e.g., M2 projection) has been provided for one or more runtime engines. Each runtime engine-specific M2 metadata model may be generated as a projection (or selected subset) of a M2 metadata model template based on one or more attributes or fields selected for the runtime engine and one or more services that have been enabled for the specific runtime engine. For example, an authorization projection has been provided for an authorization engine, in order to provide the attributes and services relevant to the authorization engine. The authorization projection, associated with the authorization engine, may include, for example, user interface metadata, documentation metadata, and access and authorization metadata. This metadata is the metadata that is needed by the authorization engine, according to an example implementation. The other metadata of M2 template are not selected to be part of the authorization projection. Similarly, a M2 UI projection is provided for the user interface engine. The UI projection may include user interface metadata and documentation metadata. These are merely some examples.

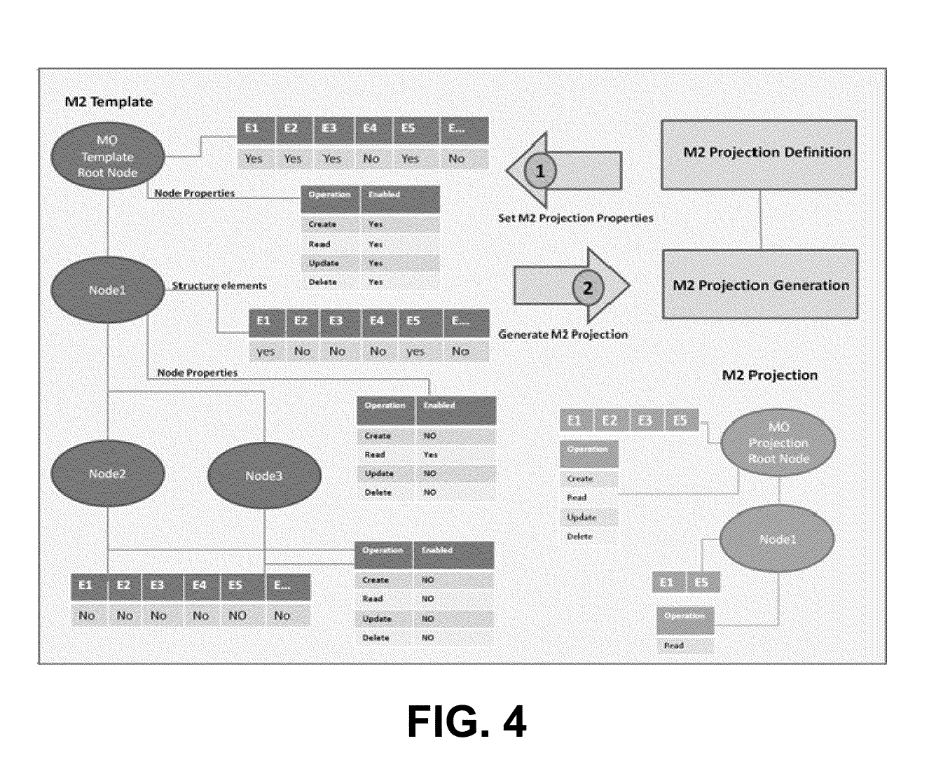

FIG. 4 is a diagram that illustrates how a M2 metadata model projection may be built from a M2 metadata model template according to an example implementation. During a creation process, or at operation 1 in FIG. 4, “set M2 projection properties”, attributes, metadata and services provided in the M2 metadata model template may be exposed or made available. The developer can select a subset of selected attributes or fields, and a subset of enabled services to be included in the projection. The subset of selected fields or attributes and enabled services may be built via setting the node-element properties as well as via enabling and disabling one or more services. For example, as shown in FIG. 4, the template root node may include one or more selected attributes or fields, such as attributes/fields E1, E2, E3 and E5 being selected for the projection (based on a “yes” as shown for each of these fields), and field/attribute E4 not being selected for the projection (based on a “no” for E4 in FIG. 4). Similarly, for the Root node, all 4 example services (Create, Read, Update and Delete or CRUD services) are enabled for this projection definition (based on the “yes” for each service under the “Enabled” column). For other M2 projections, only some of the CRUD services are enabled, for example. In this manner, a first runtime-engine-specific (or consumer-specific) projection definition may be input or received that identifies a subset of the attributes that have been selected and the services that have been enabled for a first runtime engine.

Operation 2, “generate M2 projection”, may be performed next to generate an M2 projection. This may be accomplished, for example by generating a first metadata model projection (associated with a first runtime engine) based on (e.g., as a subset of) the M2 metadata model template and the first runtime specific projection definition. A M2 projection may be generated, for example, by providing the M2 projection that identifies, from the M2 template, only attributes or fields that were selected and only services that were enabled based on the runtime specific projection definition. The resulting example M2 projection is shown in FIG. 4, and includes for Root node, E1, E2, E3 and E5 fields, and all 4 services (Create, Read, Update, and Delete); and for Node 1, only a Read operation/service was enabled and the E1 and E5 fields were selected for this projection. In this manner the M2 metadata model projection may be designed to include only the relevant nodes and attributes and services that are needed by a consumer or runtime engine, for example. The use of smaller, consumer-specific M2 metadata model projections, based on a M2 metadata model template, may allow for more efficient use of processing and memory resources and may decrease delay, since only the relevant subset of metadata is provided and consumed by the consumer or runtime engine, for example.

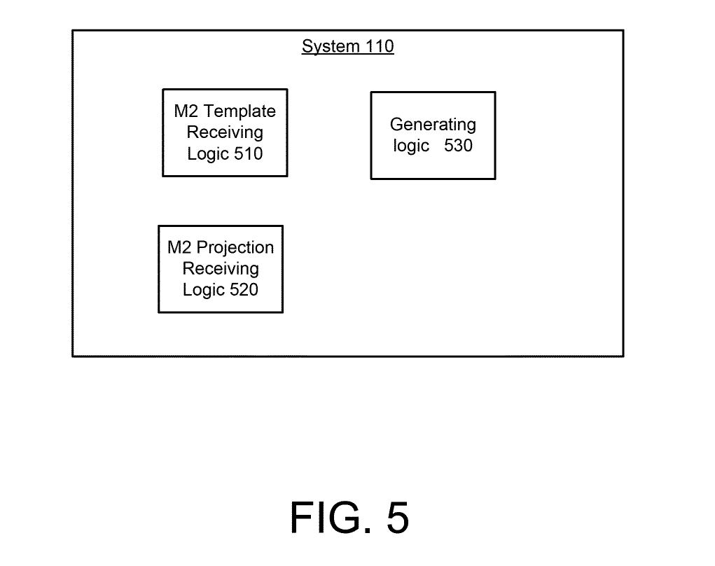

FIG. 5 is a block diagram illustrating a system 110 that uses a metadata model template and projection according to an example implementation. System 110 includes M2 template receiving logic 510 configured to receive a metadata model template that generically defines structure and behavior for a plurality of metadata models, the metadata model template identifying a union of the attributes and services needed by runtime engines associated with any of the metadata models. System 110 also includes projection definition receiving logic 520 configured to receive a first runtime engine-specific projection definition that identifies a first subset of the attributes that have been selected and the services that have been enabled for a first runtime engine. System 110 also includes generating logic 530 configured to generate a first metadata model projection based on the metadata model template and the first runtime engine-specific projection definition, the first metadata model projection associated with the first runtime engine.

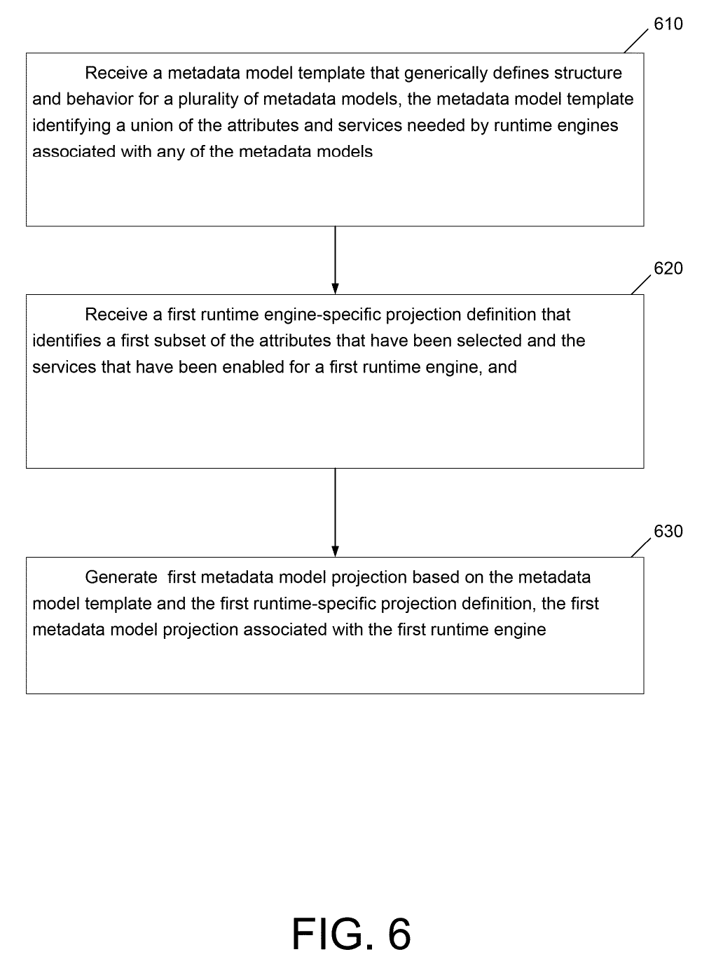

FIG. 6 is a flow chart illustrating operation of a system that uses a metadata model template and projection according to an example implementation. Operation 610 includes receiving a metadata model template that generically defines structure and behavior for a plurality of metadata models, the metadata model template including or identifying a union of the attributes and services needed by runtime engines associated with any of the metadata models. Operation 620 includes receiving a first runtime engine-specific projection definition that identifies a first subset of the attributes that have been selected and the services that have been enabled for a first runtime engine. Operation 630 includes generating a first metadata model projection based on the metadata model template and the first runtime engine-specific projection definition, the first metadata model projection associated with the first runtime engine.

Several additional operations will now be described that may also be performed according to various example implementations. In one example implementation, the method shown in FIG. 6 may further include receiving a second runtime engine-specific projection definition that identifies a second subset of the attributes that have been selected and the services that have been enabled for a second runtime engine, and generating a second metadata model projection based on the metadata model template and the second runtime engine-specific projection definition, the second metadata model projection associated with the second runtime engine.

In another example implementation, the method shown in FIG. 6 may further include updating the metadata model template to add attributes selected and services enabled for a runtime engine-specific projection each time a new metadata model projection is generated.

In another example implementation, the method shown in FIG. 6 may further include retrieving and storing model data corresponding to the metadata model template, receiving, by a model infrastructure, a request from the first runtime engine for specific data corresponding to a data model that corresponds to the first metadata model projection, and providing, to the first runtime engine, the requested data as a subset of the retrieved data for the metadata model template that corresponds to the first metadata model projection.

In another example implementation, the method shown in FIG. 6 may further include receiving, by a model infrastructure, a request from the first runtime engine for specific data corresponding to a data model that corresponds to the first metadata model projection, determining that the first metadata model projection for the first runtime engine is a projection, mapping the first metadata model projection attributes selected and services enabled to corresponding attributes and services of the first metadata model template, retrieving, by the model infrastructure, the requested data based on data retrieved for the metadata model template and the first metadata model projection, and providing the retrieved data to the first runtime engine.

In another example implementation, the method shown in FIG. 6 may further include detecting a change to a metadata model template, and invalidating one or more of the metadata model projections if any of the metadata model projections are impacted by the change.

In another example implementation, the method shown in FIG. 6 may further include automatically detecting that a change has been made to the M2 metadata model template, determining if an inconsistency exists between the first metadata model projection and the metadata model template such that the metadata model template would no longer include a union of all attributes and services of all corresponding metadata model projections, and invalidating the first metadata model projection if an inconsistency exists between the first metadata model projection and the metadata model template.

In an example implementation, model infrastructure 208 may obtain or retrieve and store all M1 model data (M0 instances) corresponding to the M2 metadata model template. In an example implementation, the M1 model data associated with a M2 template, the M2 metadata model template and associated M1 models may be stored in metadata model repository 211 of model infrastructure 208, for example. In one example, an authorization engine 226 may receive a request to authorize a user to delete an invoice. Authorization engine 226 may submit a request to model infrastructure 208 to obtain M1 model data (the corresponding M0 instances) corresponding to a M1 model (e.g., corresponding to a particular invoice or particular M1 data/M0 instance).

Therefore, in response to the request for specific M1 data, the runtime engine-specific M2 metadata model projection may be mapped to the corresponding M2 metadata model template, and the Mldata may be retrieved or selected by the model infrastructure 208. For example, the model infrastructure 208 may select the portion or subset of the previously retrieved M0 data corresponding to the M2 metadata model projection (e.g., attributes and services specified by the runtime engine-specific M2 projection) for the authorization engine. The model infrastructure 208 then provides this M1 model data (M0 instance(s) of a specific M1 model) as specified by the M2 metadata model projection to the authorization engine 226. The Authorization engine 226 may then process or consume the M1 data to perform authentication, e.g., to determine if a user is authorized to perform the requested service or method on the data.

In this manner, in order to decrease processing resources, model infrastructure 208 may make one read (or data retrieval) of M1 data/M0 instances corresponding to the M2 metadata model template, and may make multiple smaller outputs to each runtime engine to provide the relevant M1 data relevant to each consumer/runtime engine as specified by the M2 projection.

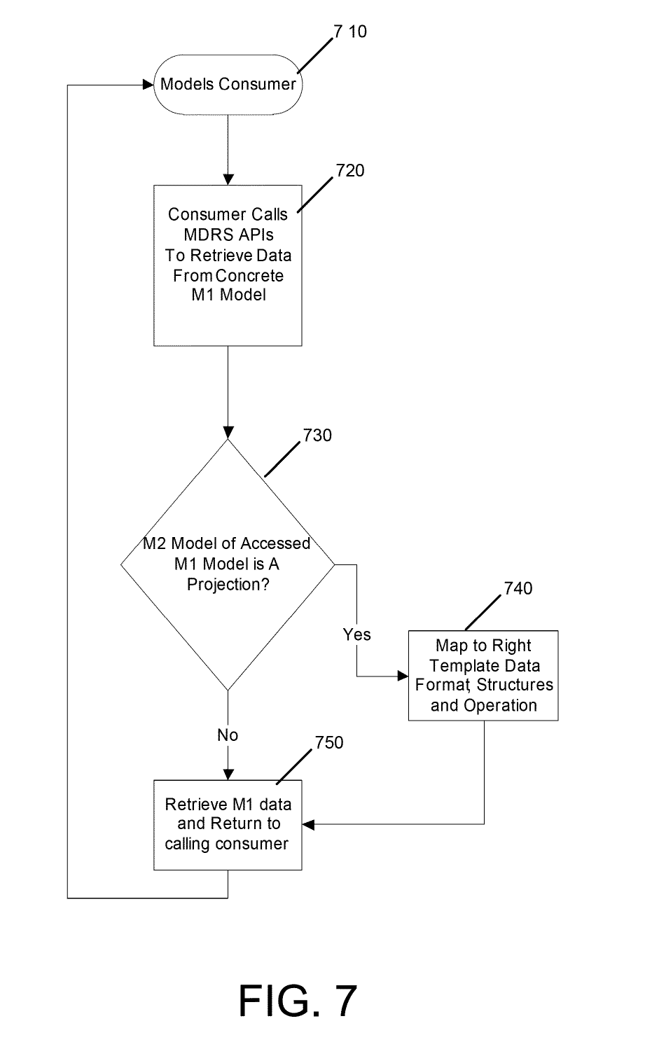

FIG. 7 is a flow chart illustrating operation of a system according to another example implementation. Block 710 shows a models consumer, e.g., a runtime engine. At 720, the consumer calls MDRS (metadata model repository 211 of model infrastructure 208) using one or more APIs (application programming interfaces) to retrieve specific M1 data corresponding to an M1 model.

At 730, it is determined by the model infrastructure 208 whether the M2 metadata model is a projection. If it is, operation proceeds to 740, where the consumer-specific M2 metadata model projection (e.g., attributes, services and other metadata) is mapped to the corresponding M2 metadata model template. Based on this mapping and the previously retrieved M1 data for the M2 metadata model template, at 750, the consumer-specific M1 data that is associated with the M2 metadata model projection is retrieved by model infrastructure 208 and then returned to the calling consumer. For example, based on the mapping of the M2 metadata model projection to the M2 metadata model template, the model infrastructure 208 may access and search M1 data database 213 and select the M1 data corresponding to the M2 projection. Or, model infrastructure 208 may select a subset of the M1 data corresponding to the M2 metadata model template that was previously retrieved by model infrastructure 208.

In addition, the template projection mechanism that is provided at the M2 metadata model level, may enable verification of M2 models integrity and consistency. According to an example implementation, business application logic 209 of model infrastructure 208, or other software or computer, may include a consistency and validation module to confirm that each M2 metadata model projection is (and remains) a valid subset of the corresponding M2 metadata model template, which should provide a union of all attributes and services that are selected or enabled for each consumer or runtime engine. For example, changes made to a M2 metadata model template may invalidate one or more corresponding M2 metadata model projections, e.g., if the attributes or services that are changed on the template will impact one or more M2 metadata models. For example, a change to a M2 metadata model template will impact a M2 metadata model projection if the changed attribute, service or metadata in the M2 metadata model template is also found in the M2 metadata model projection. A M2 projection may be invalidated if a change to a M2 metadata model template (or other change) impacts a M2 metadata model projection, since the M2 metadata model projection would no longer be a subset of the attributes and services of the M2 metadata model template. Also, in such case, the M2 metadata model template would no longer be (or include) a union of all attributes and services of all corresponding M2 metadata model projections.

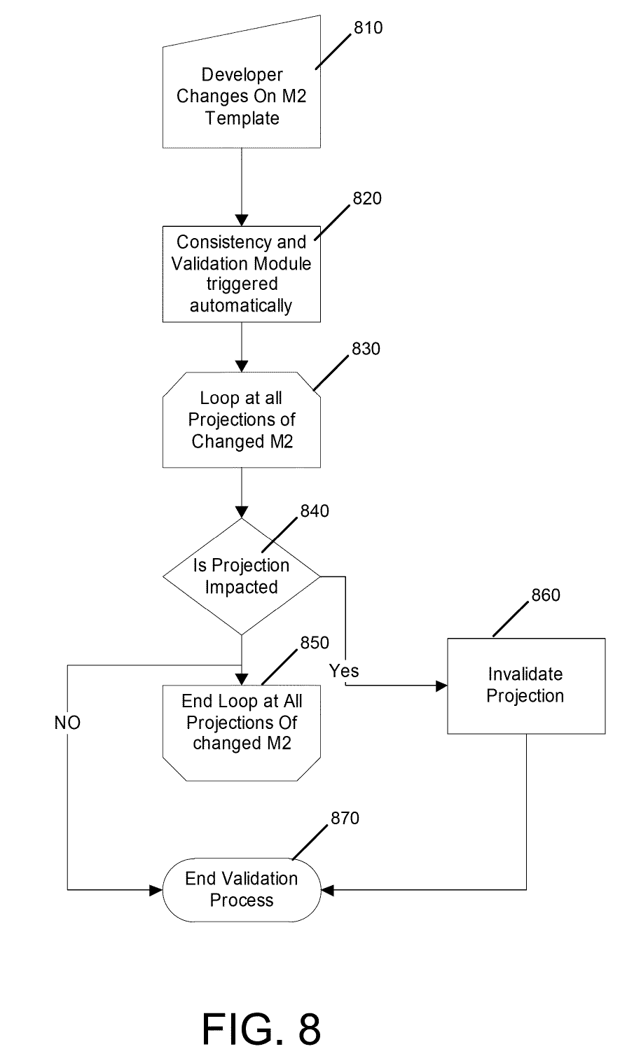

FIG. 8 is a flow chart illustrating a validation operation according to an example implementation. At 810, a developer may change one or more attributes, services or other metadata on a M2 metadata model template. At 820, in response to this change to the M2 metadata model template, a consistency and validation module is triggered or run to detect any consistency problems between the M2 metadata model template and the one or more M2 metadata model projections. The consistency and validation model may compare the structure of the M2 metadata model template to the M2 metadata model projection. This consistency and validation operation is repeated for each M2 metadata model projection, at 830. At 840, it is determined whether any of the M2 metadata model projections are impacted. If any of the M2 metadata model projections are impacted by the change to the corresponding M2 template, then operation proceeds to 860 where each impacted projection is invalidated. If the change does not impact the projection, then the loop begun at 830 is ended. The consistency and validation process is stopped at 870.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program that might implement the techniques mentioned above might be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a computer-readable storage medium and including executable code that, when executed, is configured to cause at least one data processing apparatus to:
receive a metadata model template that generically defines structure and behavior for a plurality of metadata models, the metadata model template including a union of the attributes and services needed by runtime engines associated with any of the metadata models;
receive a first runtime engine-specific projection definition that identifies a first subset of the attributes that have been selected and the services that have been enabled for a first runtime engine; and
generate a first metadata model projection based on the metadata model template and the first runtime engine-specific projection definition, the first metadata model projection associated with the first runtime engine.

2. The computer program product of claim 1 wherein the first metadata model projection includes a subset of attributes and services of the metadata model template that are needed by the first runtime engine.

3. The computer program product of claim 1 wherein the executable code is further configured to cause at least one data processing apparatus to:
receive a second runtime engine-specific projection definition that identifies a second subset of the attributes that have been selected and the services that have been enabled for a second runtime engine; and
generate a second metadata model projection based on the metadata model template and the second runtime engine-specific projection definition, the second metadata model projection associated with the second runtime engine.

4. The computer program product of claim 1 wherein the executable code is further configured to cause at least one data processing apparatus to:
update the metadata model template to add attributes selected and services enabled for a runtime engine-specific projection each time a new metadata model projection is generated.

5. The computer program product of claim 1 wherein the executable code is further configured to cause at least one data processing apparatus to:
retrieve and store model data corresponding to the metadata model template;
receive, by a model infrastructure, a request from the first runtime engine for specific data corresponding to a data model that corresponds to the first metadata model projection; and
provide, to the first runtime engine, the requested data as a subset of the retrieved data for the metadata model template that corresponds to the first metadata model projection.

6. The computer program product of claim 1 wherein the executable code is further configured to cause at least one data processing apparatus to:
receive, by a model infrastructure, a request from the first runtime engine for specific data corresponding to a data model that corresponds to the first metadata model projection;
determine that the first metadata model projection for the first runtime engine is a projection;
map the first metadata model projection attributes selected and services enabled to the first metadata model template;
retrieve, by the model infrastructure, the requested data based on data retrieved for the metadata model template and the first metadata model projection; and
provide the retrieved data to the first runtime engine.

7. The computer program product of claim 1 wherein the executable code is further configured to cause at least one data processing apparatus to:
detect a change to a metadata model template; and
invalidate one or more of the metadata model projections if any of the metadata model projections are impacted by the change.

8. The computer program product of claim 1 wherein the executable code is further configured to cause at least one data processing apparatus to:
automatically detect that a change has been made to the metadata model template;
determine if an inconsistency exists between the first metadata model projection and the metadata model template such that the metadata model template would no longer include a union of all attributes and services of all corresponding metadata model projections; and
invalidate the first metadata model projection if an inconsistency exists between the first metadata model projection and the metadata model template.

9. A computer implemented method comprising:
receiving a metadata model template that generically defines structure and behavior for a plurality of metadata models, the metadata model template including a union of the attributes and services needed by runtime engines associated with any of the metadata models;
receiving a first runtime engine-specific projection definition that identifies a first subset of the attributes that have been selected and the services that have been enabled for a first runtime engine; and
generating a first metadata model projection based on the metadata model template and the first runtime engine-specific projection definition, the first metadata model projection associated with the first runtime engine.

10. The method of claim 9 wherein the method further comprises:
receiving a second runtime engine-specific projection definition that identifies a second subset of the attributes that have been selected and the services that have been enabled for a second runtime engine; and
generating a second metadata model projection based on the metadata model template and the second runtime engine-specific projection definition, the second metadata model projection associated with the second runtime engine.

11. The method of claim 9 wherein the method further comprises:
updating the metadata model template to add attributes selected and services enabled for a runtime engine-specific projection each time a new metadata model projection is generated.

12. The method of claim 9 wherein the method further comprises:
retrieving and storing model data corresponding to the metadata model template;
receiving, by a model infrastructure, a request from the first runtime engine for specific data corresponding to a data model that corresponds to the first metadata model projection; and
providing, to the first runtime engine, the requested data as a subset of the retrieved data for the metadata model template that corresponds to the first metadata model projection.

13. The method of claim 9 wherein the method further comprises:
receiving, by a model infrastructure, a request from the first runtime engine for specific data corresponding to a data model that corresponds to the first metadata model projection;
determining that the first metadata model projection for the first runtime engine is a projection;
mapping the first metadata model projection attributes selected and services enabled to corresponding attributes and services of the first metadata model template;
retrieving, by the model infrastructure, the requested data based on data retrieved for the metadata model template and the first metadata model projection; and
providing the retrieved data to the first runtime engine.

14. The method of claim 9 wherein the method further comprises:
detecting a change to a metadata model template; and
invalidating one or more of the metadata model projections if any of the metadata model projections are impacted by the change.

15. The method of claim 9 wherein the method further comprises:
automatically detecting that a change has been made to the metadata model template;
determining if an inconsistency exists between the first metadata model projection and the metadata model template such that the metadata model template would no longer include a union of all attributes and services of all corresponding metadata model projections; and
invalidating the first metadata model projection if an inconsistency exists between the first metadata model projection and the metadata model template.

16. An apparatus comprising:
template receiving logic configured to receive a metadata model template that generically defines structure and behavior for a plurality of metadata models, the metadata model template including a union of the attributes and services needed by runtime engines associated with any of the metadata models;
projection definition receiving logic configured to receive a first runtime engine-specific projection definition that identifies a first subset of the attributes that have been selected and the services that have been enabled for a first runtime engine; and
generating logic configured to generate a first metadata model projection based on the metadata model template and the first runtime engine-specific projection definition, the first metadata model projection associated with the first runtime engine.

17. The apparatus of claim 16 wherein the first metadata model projection includes a subset of attributes and services of the metadata model template that are needed by the first runtime engine.

18. The apparatus of claim 16 wherein the apparatus is further configured to:
receive a second runtime engine-specific projection definition that identifies a second subset of the attributes that have been selected and the services that have been enabled for a second runtime engine; and
generate a second metadata model projection based on the metadata model template and the second runtime engine-specific projection definition, the second metadata model projection associated with the second runtime engine.

19. The apparatus of claim 16 wherein the apparatus is further configured to:
update the metadata model template to add attributes selected and services enabled for a runtime engine-specific projection each time a new metadata model projection is generated.

20. The apparatus of claim 16 wherein the apparatus is further configured to:
retrieve and store model data corresponding to the metadata model template;
receive, by a model infrastructure, a request from the first runtime engine for specific data corresponding to a data model that corresponds to the first metadata model projection; and
provide, to the first runtime engine, the requested data as a subset of the retrieved data for the metadata model template that corresponds to the first metadata model projection.

21. The apparatus of claim 16 wherein the apparatus is further configured to:
receive, by a model infrastructure, a request from the first runtime engine for specific data corresponding to a data model that corresponds to the first metadata model projection;
determine that the first metadata model projection for the first runtime engine is a projection;
map the first metadata model projection attributes selected and services enabled to the first metadata model template;
retrieve, by the model infrastructure, the requested data based on data retrieved for the metadata model template and the first metadata model projection; and
provide the retrieved data to the first runtime engine.

22. The apparatus of claim 16 wherein the apparatus is further configured to:
detect a change to a metadata model template; and
invalidate one or more of the metadata model projections if any of the metadata model projections are impacted by the change.

23. The apparatus of claim 16 wherein the apparatus is further configured to:
automatically detect that a change has been made to the metadata model template;
determine if an inconsistency exists between the first metadata model projection and the metadata model template such that the metadata model template would no longer include a union of all attributes and services of all corresponding metadata model projections; and
invalidate the first metadata model projection if an inconsistency exists between the first metadata model projection and the metadata model template.
